(19) United States
(12) Patent Application Publication
(10) Pub. No.: US 2013/0170538 A1
(43) Pub. Date: Jul. 4, 2013

(54) EQUALIZER RECEIVER AND OPERATING METHOD THEREOF IN WIRELESS COMMUNICATION SYSTEM

(71) Applicant: Samsung Electronics Co. Ltd., Suwon-si (KR)

(72) Inventors: Young-Min KI, Yongin-si (KR); Se-Jin KONG, Suwon-si (KR); Seong-Wook SONG, Gwacheon-si (KR); Kyung-Ha LEE, Yongin-si (KR)

(73) Assignee: SAMSUNG ELECTRONICS CO. LTD., Suwon-si (KR)

(21) Appl. No.: 13/723,997

(22) Filed: Dec. 21, 2012

(30) Foreign Application Priority Data
Dec. 28, 2011 (KR) 10-2011-0144187

(51) Int. Cl. H04L 27/01

(52) U.S. Cl. CPC H04L 27/01
USPC 375/231

(57) ABSTRACT

An equalizer-based receiver and an operating method thereof in a wireless communication system are provided. The equalizer-based receiver includes a reception multi-path detector, a controller, and an equalize receiver. The reception multi-path detector groups reception signals according to a predetermined reference to classify the reception signals into a plurality of delay clusters, and estimates a position of the plurality of delay clusters. The controller determines whether the plurality of delay clusters exist within a predetermined threshold range based on a result of the estimated position, and controls an operation mode of the equalizer-based receiver depending on a result of the determination. The equalize receiver performs one of a mode for removing an interference between the plurality of delay clusters and a mode for applying a diversity technique to a delay cluster under control of the controller.

### PRIORITY

This application claims the benefit under 35 U.S.C. §119(a) of a Korean patent application filed on Dec. 28, 2011 in the Korean Intellectual Property Office and assigned Serial No. 10-2011-0144187, the entire disclosure of which is hereby incorporated by reference.

### BACKGROUND OF THE INVENTION

1. Field of the Invention

The present invention relates to a structure of an equalizer receiver and an operating method thereof in a wireless communication system.

2. Description of the Related Art

Recently, as a high speed mobile communication system requiring high speed data transmission such as Wideband Code Division Multiple Access (WCDMA) and High Speed Downlink Packet Access (HSDPA) is standardized and commercialized, an equalizer-based receiver suitable for high speed reception is studied and developed in various forms.

The conventional equalizer-based receiver includes a multi-tap channel estimator having a multi-tap of a sufficiently long length and an equalizer in preparation for a situation where a delay profile of a multi-path reception channel appears long. However, since the delay profile of a long length does not always appear in an actual channel reception environment, the conventional receiver selectively uses a multi-tap with consideration of a channel environment. For example, the receiver uses a method of activating only a necessary tap among multi-taps by estimating a delay profile of a reception signal depending on a multi-path, and inactivating the rest of taps to receive a signal. However, the above-described technique of selecting and using only a portion of taps among the multi-taps has a fundamental disadvantage of still having to have a multi-tap of a long length in order to guarantee performance.

Also, the equalizer-based receiver according to the conventional art uses a method of allowing a terminal to operate in a way of statistically modeling a transmission signal and a reception signal for multi-path fading corresponding to a window size of an equalizer among serving cell (or own cell) signals, and calculating an equalizer tap coefficient using the modeled signal, and generating a noise signal representing a characteristic for a noise and an interference by estimating a Signal to Noise Ratio (SNR) and modeling using an Additive White Gaussian Noise (AWGN). As described above, the conventional receiver operates by modeling a case where a multi-path fading signal is received inside a window size of an equalizer under an environment of small delay spread as illustrated in FIG. 1A. Accordingly, under a multi-path fading reception environment having a delay spread larger than the window size of the equalizer, as illustrated in FIG. 1B, in the case where a delay cluster 110 exists outside the equalizer window, a reception performance of the receiver deteriorates due to reception energy loss and interference by the delay cluster 110. Of course, in this case, a problem under the multi-path fading reception environment may be overcome by increasing the window size of the equalizer, but an increase in the window size of the equalizer not only increases complexity of an equalizer adaptive operation geometrically but also generates an inefficiency problem under an environment where a fading reception signal of small delay spread is received.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a structure of an equalizer receiver and an operating method thereof in a wireless communication system.

Another aspect of the present invention is to provide a method and an apparatus for classifying multi-path delay signals received under a multi-path fading environment into a plurality of delay clusters and controlling an operating method of a receiver depending on distribution of the plurality of delay clusters in a wireless communication system.

Still another aspect of the present invention is to provide a method and an apparatus for removing an interference of other delay clusters with respect to a delay cluster whose reception power is largest among a plurality of delay clusters in a receiver of a wireless communication system.

Yet another aspect of the present invention is to provide a method and an apparatus for removing an interference of other delay clusters with respect to each of a plurality of delay clusters in a receiver of a wireless communication system, and coupling results thereof.

Still yet another aspect of the present invention is to provide a method and an apparatus for applying a diversity reception technique to a plurality of delay clusters in a wireless communication system.

In accordance with an aspect of the present invention, an apparatus of an equalizer-based receiver in a wireless communication system is provided. The apparatus includes a reception multi-path detector for grouping reception signals according to a predetermined reference to classify the signals into a plurality of delay clusters, and for estimating a position of the plurality of delay clusters, a controller for determining whether the plurality of delay clusters exist within a predetermined threshold range based on a result of the estimated position, and for controlling an operation mode of the equalizer-based receiver depending on a result of the determination, and an equalize receiver for performing one of a mode for removing an interference between the plurality of delay clusters and a mode for applying a diversity technique to a delay cluster under control of the controller.

In accordance with another aspect of the present invention, a method for operating an equalizer-based receiver in a wireless communication system is provided. The method includes grouping reception signals according to a predetermined reference to classify the signals into a plurality of delay clusters, estimating a position of the plurality of delay clusters, determining whether the plurality of delay clusters exist within a predetermined threshold range using a results of the estimated position estimated, and operating in one of a mode for removing an interference between the plurality of delay clusters and a mode for applying a diversity technique to a delay cluster depending on a result of the determination.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIGS. 1A and 1B are views illustrating a performance loss of an equalizer-based receiver according to the conventional art;

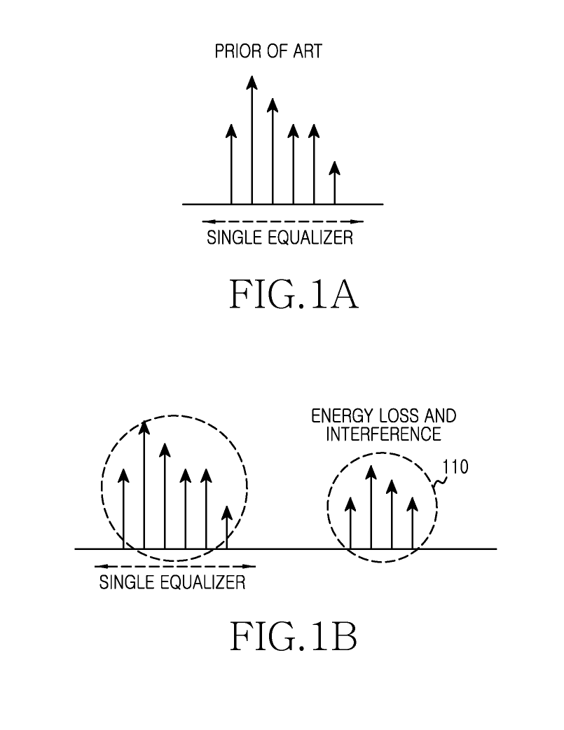

FIG. 2 is a block diagram illustrating an equalizer-based receiver according to an exemplary embodiment of the present invention;

FIG. 3 is a flowchart illustrating a procedure for operating an equalized-based receiver according to an exemplary embodiment of the present invention;

FIGS. 4A to 4C are views illustrating an operating method of an equalizer-based receiver according to an exemplary embodiment of the present invention;

FIG. 5 is a detailed block diagram illustrating an equalize receiver for removing an interference between delay clusters according to an exemplary embodiment of the present invention;

FIG. 6 is a detailed block diagram illustrating a PN generator and a multi-cluster channel estimator according to an exemplary embodiment of the present invention;

FIG. 7 is a detailed block diagram illustrating a multi-cluster adaptive equalizer according to an exemplary embodiment of the present invention;

FIG. 8 is a detailed block diagram illustrating an equalize receiver for removing and coupling an interference between delay clusters according to an exemplary embodiment of the present invention;

FIG. 9 is a detailed block diagram illustrating a multi-cluster adaptive equalizer according to an exemplary embodiment of the present invention;

FIG. 10 is a detailed block diagram illustrating a multi-cluster equalizer FIR filter and a multi-cluster coupler according to an exemplary embodiment of the present invention;

FIG. 11 is a detailed block diagram illustrating an equalize receiver for applying a diversity technique to a delay cluster according to an exemplary embodiment of the present invention;

FIG. 12 is a detailed block diagram illustrating a multi-cluster diversity adaptive equalizer according to an exemplary embodiment of the present invention; and

FIG. 13 is a detailed block diagram illustrating a multi-cluster equalizer FIR filter and a multi-cluster coupler according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and an apparatus for classifying multi-path delay signals received under a multi-path fading environment into a plurality of delay clusters, and controlling an operating method of a receiver depending on distribution of the plurality of delay clusters in a wireless communication system. Here, the delay cluster denotes a multi-delay signal group.

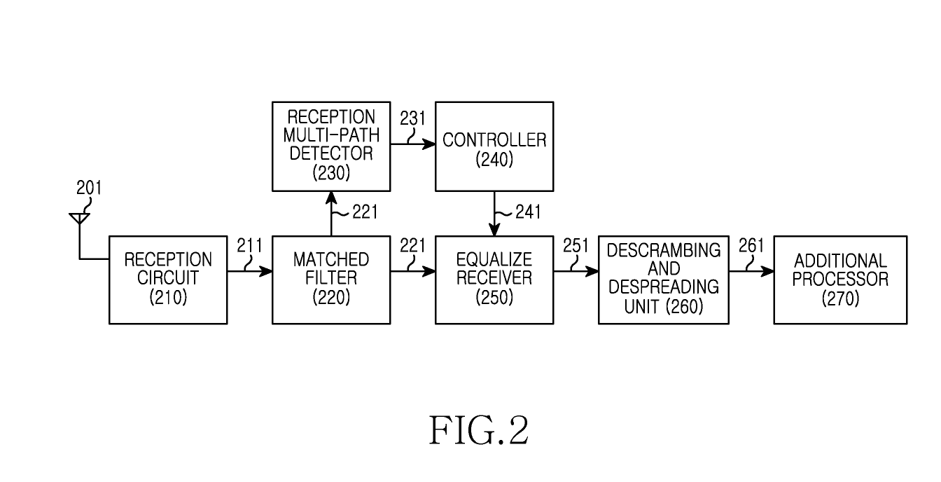

FIG. 2 is a block diagram illustrating an equalizer-based receiver according to an exemplary embodiment of the present invention.

Referring to FIG. 2, the equalizer-based receiver includes an antenna 201, a reception circuit 210, a matched filter 220, a reception multi-path detector 230, a controller 240, an adaptive equalize receiver 250, a descrambling and despreading unit 260, and an additional processor 270.

First, the matched filter 220 performs matched filtering on a signal 211 received via the antenna 201 and the reception circuit 210 and a reference signal stored in advance to provide the same to the reception multi-path detector 230.

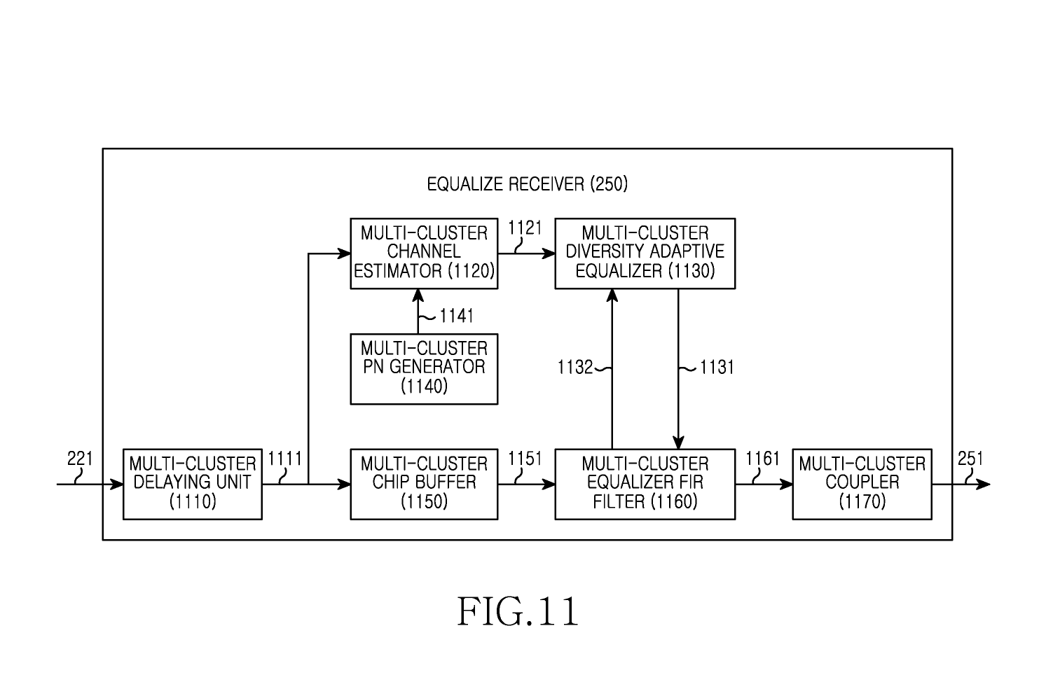

The reception multi-path detector 230 analyzes a signal 221 received from the matched filter 220 to detect a multi-path delay signal, and groups multi-path delay signals according to a predetermined reference to classify the same into a plurality of delay clusters. Particularly, the reception multi-path detector 230 retrieves a position of a multi-delay cluster to determine whether the multi-delay cluster exists within a predetermined window range, and provide the determination result through signal 231 to the controller 240. Here, the predetermined window range may be set as an output delay window size of the multi-cluster delay 1110 illustrated in FIG. 11.

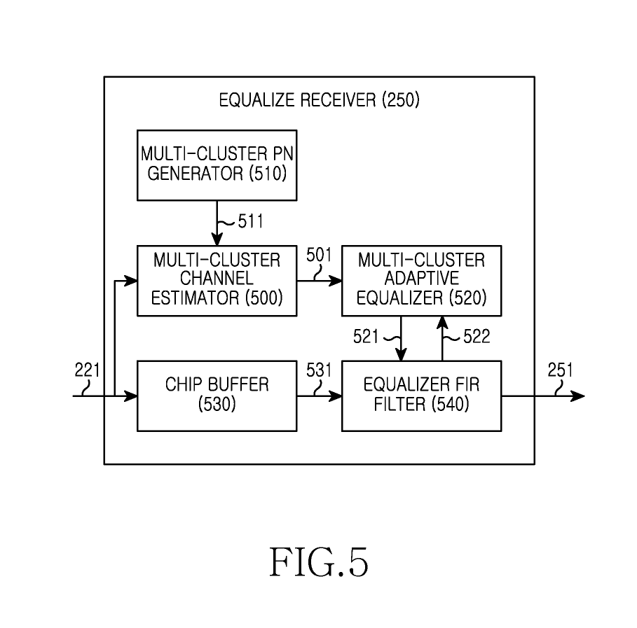

The controller 240 controls an operating method of the equalize receiver 250 depending on the determination result 231 provided from the reception multi-path detector 230. That is, when the multi-delay cluster does not exist within the predetermined window range, the controller 240 controls the equalize receiver 250 to operate in a delay cluster interference remove mode or a delay cluster interference remove and couple mode through signal 241. When the multi-delay cluster exists within the predetermined window range, the controller 240 controls the equalize receiver 250 to operate in a delay cluster diversity mode. Also, the controller 240 receives a signal informing existence of one delay cluster from the reception multi-path detector 230. At this point, the controller 240 may control the equalize receiver 250 to operate in the conventional way in order to receive the one delay cluster. Here, the delay cluster interference remove mode denotes a method of treating each delay cluster signal as a separate signal, removing an interference of other delay clusters with respect to a delay cluster of a largest reception strength, and then performing an equalize process. The delay cluster interference remove and couple mode denotes a method of treating each delay cluster signal as a separate signal, removing an interference between delay clusters, performing an equalize process, and summing results thereof. Also, the delay cluster diversity mode denotes a method of treating each delay cluster signal as a signal by a diversity path, and calculating an equalizer FIR filter coefficient for each delay cluster via Linear Minimum Mean Square Error (LMMSE) coupling. Detailed description thereof is made with reference to FIGS. 5 to 13.

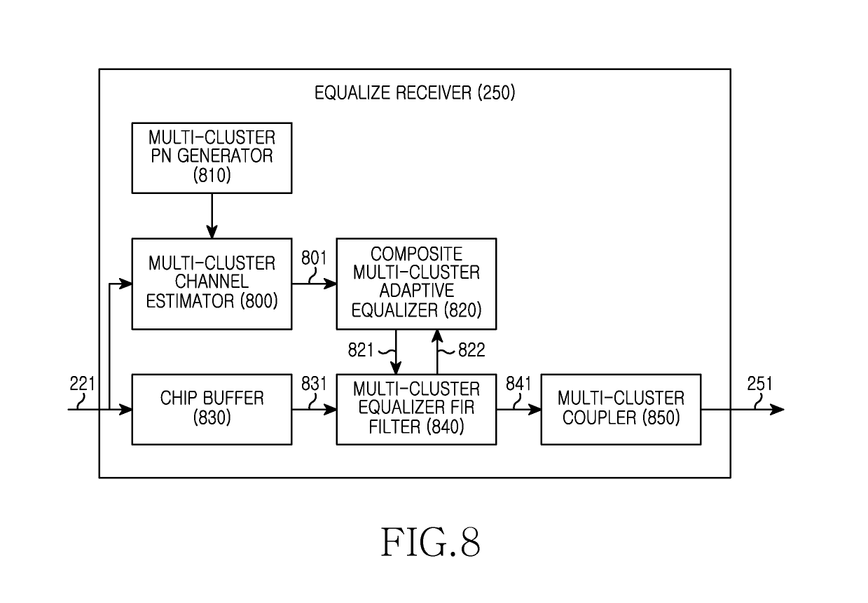

The equalize receiver 250 estimates a channel for an input signal, generates an equalizer FIR filter coefficient using the channel estimated result, performs an equalize process to compensate for signal distortion by a transmission path. Particularly, the equalize receiver 250 may operate in one of the delay cluster interference remove mode, the delay cluster interference remove and couple mode, and the delay cluster diversity mode under control of the controller 240 by including the construction of FIGS. 5, 8, and 11. That is, the equalize receiver 250 may operate in the delay cluster interference remove mode via the construction illustrated in FIG. 5, operate in the delay cluster interference remove and couple mode via the construction illustrated in FIG. 8, and operate in the delay cluster diversity mode via the construction illustrated in FIG. 11. Here, a detailed operation of the equalize receiver 250 according to each mode is described in detail with reference to FIGS. 5, 8, and 11.

The descrambling and despreading unit 260 performs descrambling and despreading on an equalized signal 251 output from the equalize receiver 250, and the additional processor 270 performs additional processing on the despread signal 261 to recover an information signal.

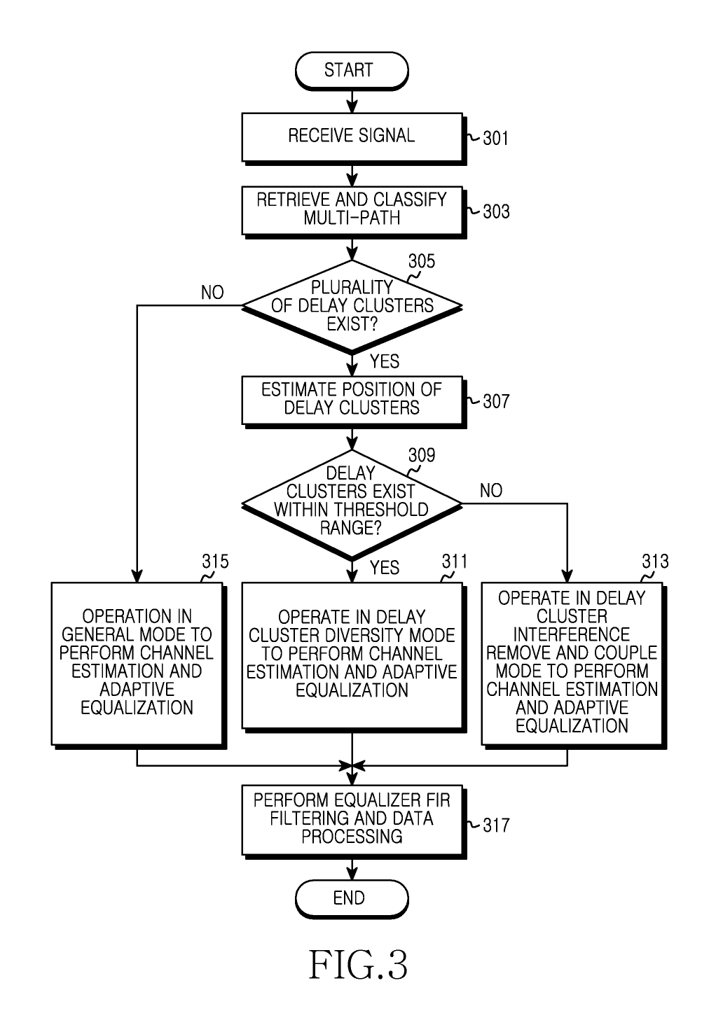

FIG. 3 is a flowchart illustrating a procedure for operating an equalized-based receiver according to an exemplary embodiment of the present invention.

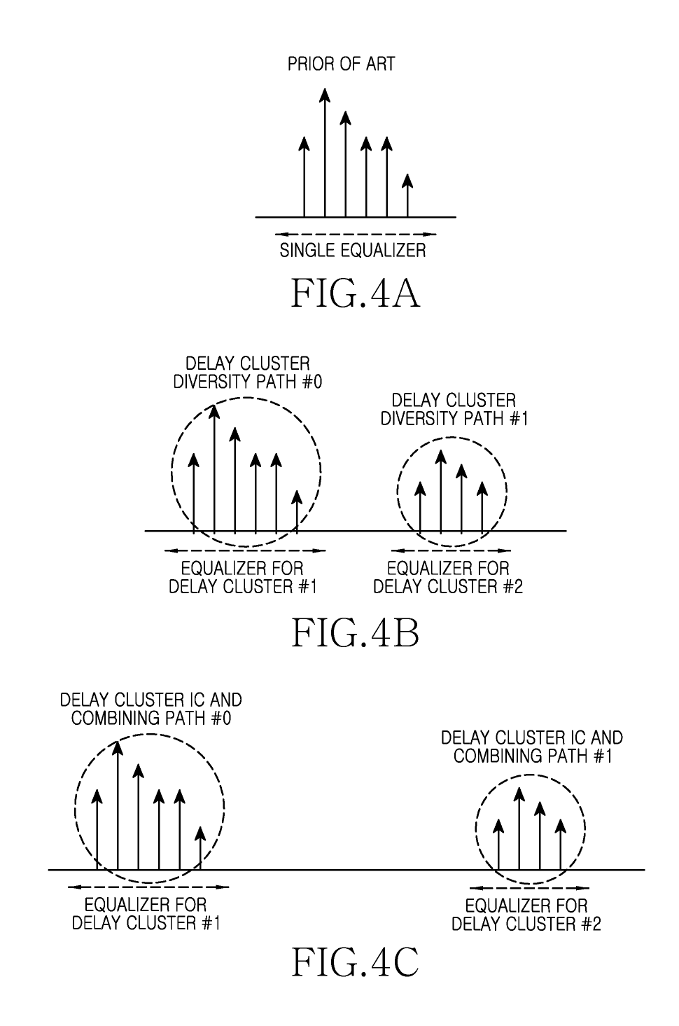

FIGS. 4A to 4C are views illustrating an operating method of an equalizer-based receiver according to an exemplary embodiment of the present invention.

Referring to FIG. 3, the equalizer-based receiver receives a signal in step 301, proceeds to step 303 to analyze received signals to detect multi-path delay signals, and group the multi-path delay signals according to a predetermined reference to classify the same into a plurality of delay clusters.

The equalizer-based receiver determines whether the plurality of delay clusters exist in step 305. When the plurality of delay clusters do not exist, the equalizer-based receiver operates in a general mode to perform a channel estimation and an adaptive equalize process in step 315. Here, as well known in the conventional art, the general mode denotes performing channel estimation and an equalize process as in a single cell environment. For example, as illustrated in FIG. 4A, in the case where only one delay cluster exists, the equalizer-based receiver, as known in the conventional art, operates in a way of calculating an equalizer tap coefficient using a signal obtained by statistically modeling a transmission signal and a reception signal for multi-path fading corresponding to a window size of an equalizer among serving cell (or own cell) signals.

In contrast, when the plurality of delay clusters exist, the equalizer-based receiver estimates a position of the plurality of delay clusters in step 307, and proceeds to step 309 to determine whether the plurality of delay clusters, that is, multi-delay clusters exist within a predetermined window range. Here, the predetermined window range may be set as an output delay window size of the multi-cluster delay illustrated in FIG. 11.

When the multi-delay clusters exist within the predetermined window range, the equalizer-based receiver proceeds to step 311 to operate in the delay cluster diversity mode and perform channel estimation and an adaptive equalize process. For example, as illustrated in FIG. 4B, in the case where two delay clusters exist within the predetermined window range, the equalizer-based receiver may apply a diversity reception technique to the two delay clusters. Here, the channel estimation and the adaptive equalize process of the delay cluster diversity mode are described in detail with reference to FIG. 11.

In contrast, in the case where the multi-delay clusters do not exist within the predetermined window range, the equalizer-based receiver proceeds to step 313 to operate in the delay cluster interference remove mode or the delay cluster interference remove and couple mode and perform the channel estimation and the adaptive equalize process. For example, as illustrated in FIG. 4C, in the case where two delay clusters do not exist within the predetermined window range, the equalizer-based receiver may apply a technique of removing and coupling interferences to each of the two delay clusters. Here, the channel estimation and the adaptive equalize process of the delay cluster interference remove mode are described in detail with reference to FIG. 5, and the channel estimation and the adaptive equalize process of the delay cluster interference remove and couple mode are described in detail with reference to FIG. 8. Finally, after performing any of steps 315, 311 and 313, a Finite Impulse response (FIR) filtering and data processing is performed at step 317 and the process ends.

FIG. 5 is a detailed block diagram illustrating an equalize receiver 250 for removing an interference between delay clusters according to an exemplary embodiment of the present invention.

Referring to FIG. 5, the equalize receiver 250 includes a multi-cluster channel estimator 500, a multi-cluster PN generator 510, a multi-cluster adaptive equalizer 520, a chip buffer 530, and an equalizer FIR filter 540.

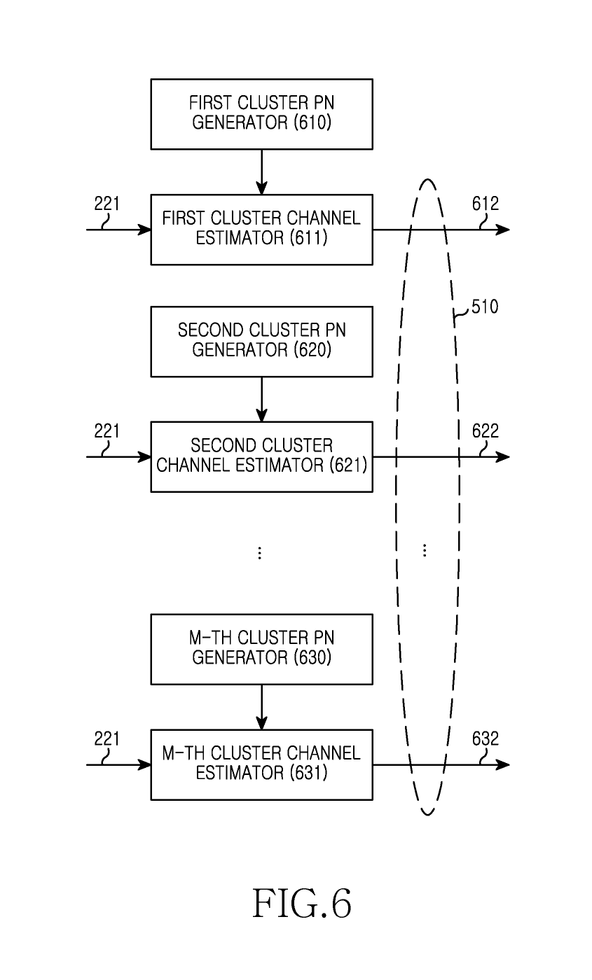

First, the multi-cluster PN generator 510 generates a PN code corresponding to each of the multi-delay clusters by differing timing with respect to each of the multi-delay clusters, and outputs the generated PN code 511 to the multi-cluster channel estimator 500. At this point, the multi-cluster PN generator 510 may include M PN generators 610, 620, 630 for generating a PN code for each of M delay clusters as illustrated in FIG. 6 with consideration of difference in a received delay offset of each multi-delay cluster.

The multi-cluster channel estimator 500 receives an output data signal 221 of the matched filter 220 to perform channel estimation on a multi-delay cluster. That is, as illustrated in FIG. 6, the multi-cluster channel estimator 500 includes M cluster channel estimators 611, 621, 631 for estimating a channel for each of M delay clusters. Here, M denotes the number of delay clusters having meaningful reception power. For example, M may be the number of delay clusters having reception power greater than a predetermined threshold. In an exemplary embodiment of the present invention, a delay cluster having largest reception power among delay clusters having reception power greater than the predetermined threshold is referred to as a main cluster, and the main cluster is set as a first delay cluster.

Referring to FIG. 6, a first cluster channel estimator 611 of the multi-cluster channel estimator 500 receives a PN code for the first delay cluster from the first cluster PN generator 610 to perform channel estimation for the first delay cluster in a data signal 221 input from the matched filter 220 and output a channel estimated value 612 for successive N taps. A second cluster channel estimator 621 receives a PN code from the second delay cluster from the second cluster PN generator 620 to estimate a channel for the second delay channel in a data signal 221 input from the matched filter 220 and output a channel estimated value 622 for successive N taps. Likewise, an M-th cluster channel estimator 631 receives a PN code for the M-th delay cluster from the M-th cluster PN generator 630 to estimate a channel for the M-th delay cluster in a data signal 221 input from the matched filter 220 and output a channel estimated value 632 for successive N taps.

Also, though not shown, according to an exemplary embodiment of the present invention, each of the cluster channel estimators 611, 621, 631 may include a multi-tap channel estimator for performing channel estimation on successive N taps. At this point, the multi-tap channel estimator for performing channel estimation on the N taps may be configured as known in the conventional art. For example, each of the cluster channel estimators 611, 621, 631 may include a plurality of subchannel estimators for receiving an on-sample or a half chip late-sample for a data signal 221 output from the matched filter 220 and receiving a corresponding PN signal to perform despreading and noise filtering, and a plurality of chip delaying units for delaying the corresponding PN signal by a predetermined chip.

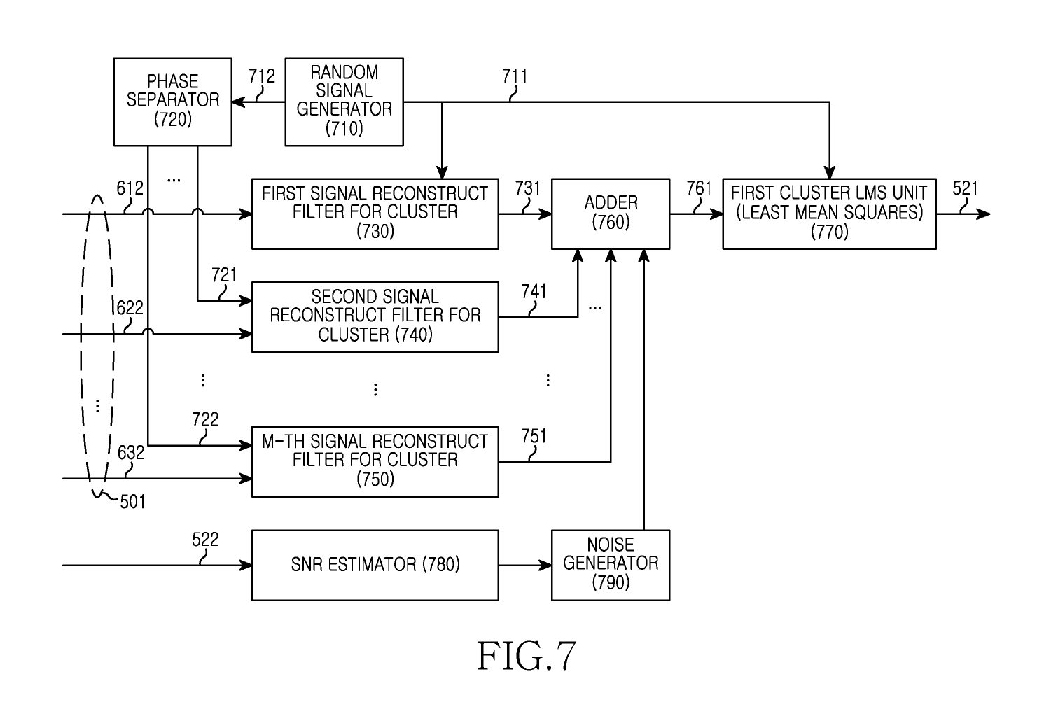

The multi-cluster adaptive equalizer 520 generates an equalizer FIR filter tap coefficient using channel estimated values 501, 612, 622, 632 for respective multi-delay clusters output from the multi-cluster channel estimator 500, and outputs the generated tap coefficient 521 to the equalizer FIR filter 540. Particularly, the multi-cluster adaptive equalizer 520 proposed by an exemplary embodiment of the present invention is configured as illustrated in FIG. 7 to generate only a value corresponding to a main cluster having largest reception power among the multi-delay clusters as the equalizer FIR filter tap coefficient 521. The multi-cluster adaptive equalizer 520 is described below in detail with reference to FIG. 7.

Referring to FIG. 7, the multi-cluster adaptive equalizer 520 includes a phase separator 720, a random signal generator 710, M signal reconstruct filters for cluster 730, 740, 750, an adder 760, a first cluster Least Mean Square (LMS) unit 770, an SNR estimator 780, and a noise generator 790.

First, the random signal generator 710 generates and outputs a random signal whose statistical characteristic is similar to a transmission signal of a base station. For example, the random signal generator 710 may be a memory where 1 or −1 of a length of 2048 are mixed at random and stored.

The phase separator 720 receives a random signal 712 output from the random signal generator 710 to generate a plurality of random signals 721, 722 having different phases, and outputs random signals of different phases to the second signal reconstruct filter for cluster 740 and the M-th signal reconstruct filter for cluster 750. For example, the phase separator 720 may receive a random signal to generate (M−1) random signals of different phases. Here, the phase separator 720 generates (M−1) random signals because the first signal reconstruct filter for cluster 740 processing a main cluster uses a random signal output from the random signal generator 710 as it is. That is, the phase separator 720 controls random signals input to the M signal reconstruct filters for cluster 730, 740, 750, respectively, to have different phases.

The first signal reconstruct filter for cluster 730 receives a channel estimated value 612 of the main delay cluster output from the first cluster estimator 611 to set the same as a FIR filter tap coefficient, and filters a random signal 711 output from the random signal generator 710 to generate a random signal 731 whose statistical characteristic is similar to a main cluster reception signal.

The second signal reconstruct filter for cluster 740 receives a channel estimated value 622 of the second delay cluster output from the second cluster estimator 621 to set the same as a FIR filter coefficient, and filters a random signal output from the phase separator 720 to generate a random signal 741 whose statistical characteristic is similar to a second cluster reception signal.

Likewise, the M-th signal reconstruct filter for cluster 750 receives a channel estimated value 632 of the M-th delay cluster output from the M-th cluster estimator 631 to set the same as a FIR filter tap coefficient and filters a random signal output from the phase separator 720 to generate a random signal 751 whose statistical characteristic is similar to an M-th cluster reception signal.

The SNR estimator estimates an SNR using an equalized signal output 522 of the equalizer FIR filter 540, and provides the same to the noise generator 790. The noise generator 790 generates a noise signal based on the estimated SNR and outputs the same. At this point, the SNR estimator 780 and the noise generator 790 may improve a convergence performance of an LMS algorithm of the first cluster LMS unit 770 by modeling a noise using Additive White Gaussian Noise (AWGN) and artificially generating a noise signal with respect to a noise and an interference portion that cannot be modeled by the signal reconstruct filter.

The adder 760 adds statistical random signals 731, 741, 751 output from the M signal reconstruct filters for cluster 730, 740, 750, and a noise signal of the noise generator 790 to output the same to the first cluster LMS unit 770. At this point, an output signal 761 of the adder 760 becomes a random signal whose statistical characteristic is similar to a multi-delay cluster reception signal.

The first cluster LMS unit 770 generates and outputs a tap coefficient 521 of the equalizer FIR filter 540 by performing adaptive filtering on the signal 761 whose statistical characteristic is similar to the multi-cluster reception signal using the random signal 711 output from the random signal generator 710, that is, the random signal 711 whose statistical characteristic is similar to a transmission signal of a base station as a reference signal. Here, the equalizer FIR filter tap coefficient generated by the first cluster LMS unit 770 is expressed by Equation (1).

$$W = {[ {H}_{1} {H}_{1}^{H} + {\sum }_{j = 2}^{M} {H}_{j} {H}_{J}^{H} + {σ}^{2} I ]}^{- 1} {H}_{1}^{H} \qquad ( 1 )$$

where Hⱼ is a channel estimated value for a j-th delay cluster, and j has a value of 1, 2, . . . , M. Also, σ²I is a noise signal generated by the noise generator 790.

The equalizer FIR filter 540 performs an equalize process using a signal 531 stored in and transferred from the chip buffer 530 and a FIR filter coefficient 521 output from the multi-cluster adaptive equalizer 520.

FIG. 8 is a detailed block diagram illustrating an equalize receiver for removing and coupling an interference between delay clusters according to an exemplary embodiment of the present invention.

Referring to FIG. 8, the equalize receiver includes a multi-cluster channel estimator 800 outputting a channel estimator value 801, a multi-cluster PN generator 810, a composite multi-cluster adaptive equalizer 820, a chip buffer 830, a multi-equalizer FIR filter 840, and a multi-cluster coupler 850. Here, since the multi-cluster channel estimator 800, the multi-cluster PN generator 810, and the chip buffer 830 are the same as the multi-cluster channel estimator 500, the multi-cluster PN generator 510, and the chip buffer 530 illustrated in FIG. 5, and perform the same operations, descriptions thereof are omitted.

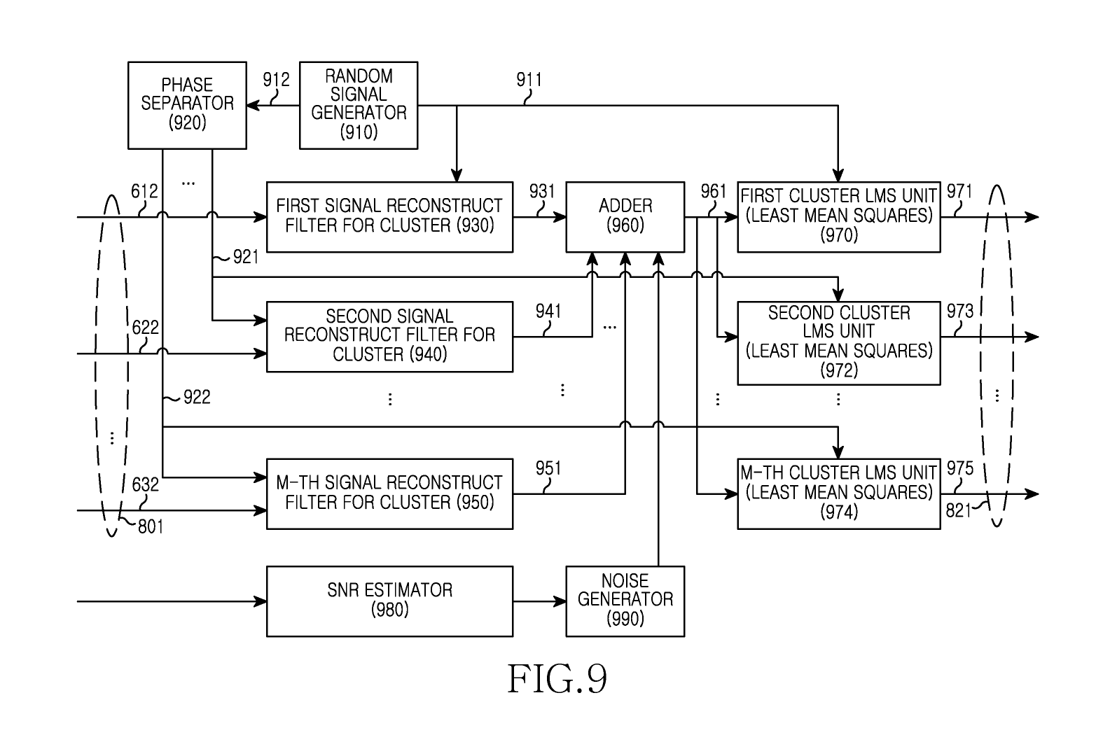

The composite multi-cluster adaptive equalizer 820 generates an equalizer FIR filter tap coefficient for respective multi-delay clusters using channel estimated values 501, 612, 622, 632 for respective multi-delay clusters output from the multi-cluster channel estimator 500, and outputs the generated tap coefficient 821 to the multi-equalizer FIR filter 840. Particularly, the composite multi-cluster adaptive equalizer 820 proposed by an exemplary embodiment of the present invention is configured as illustrated in FIG. 9 to generate equalizer FIR filter tap coefficients 821, 971, 973, 975 for the respective multi-delay clusters. The composite multi-cluster adaptive equalizer 820 is described below in detail with reference to FIG. 9.

Referring to FIG. 9, the composite multi-cluster adaptive equalizer 820 includes a phase separator 920, a random signal generator 910, M signal reconstruct filters for cluster 930, 940, 950, an adder 960, M cluster Least Mean Square (LMS) units 970, 972, 974, an SNR estimator 980, and a noise generator 990.

First, the random signal generator 910 generates and outputs a random signal whose statistical characteristic is similar to a transmission signal of a base station. For example, the random signal generator 910 may be a memory where 1 or −1 of a length of 2048 are mixed at random and stored.

The phase separator 920 receives a random signal 912 output from the random signal generator 910 to generate a plurality of random signals having different phases, and outputs random signals 921, 922 of different phases to the second signal reconstruct filter for cluster 940, the M-th signal reconstruct filter for cluster 950, the second cluster LMS unit 972, and the M-th cluster LMS unit 974. At this point, the phase separator 920 outputs the same random signal to the reconstruct filter processing the same delay clusters and the LMS unit. For example, the phase separator 920 receives a random signal 912 to generate (M−1) random signals of different phases, outputs a generated first random signal to the second signal reconstruct filter for cluster 940 and the second cluster LMS unit 972, and outputs an (M−1)-th random signal to the M-th signal reconstruct filter for cluster 950 and the M-th cluster LMS unit 974. Here, the phase separator 920 generates (M−1) random signals because the first signal reconstruct filter for cluster 930 processing a main cluster uses a random signal output from the random signal generator 910 as it is. That is, the phase separator 920 controls random signals input to the M signal reconstruct filters for cluster 930, 940, 950, and the M LMS units 970, 972, 974, respectively, to have different phases.

The first signal reconstruct filter for cluster 930 receives a channel estimated value 612 of a main delay cluster output from the first cluster estimator 611 to set the same as a FIR filter tap coefficient, and filters a random signal 911 output from the random signal generator 910 to generate a random signal 931 whose statistical characteristic is similar to a main cluster reception signal.

The second signal reconstruct filter for cluster 940 receives a channel estimated value 622 of a second delay cluster output from the second cluster estimator 621 to set the same as a FIR filter coefficient, and filters a random signal 921 output from the phase separator 920 to generate a random signal 941 whose statistical characteristic is similar to a second cluster reception signal.

Likewise, the M-th signal reconstruct filter for cluster 950 receives a channel estimated value 632 of the M-th delay cluster output from the M-th cluster estimator 631 to set the same as a FIR filter tap coefficient, and filters a random signal 922 output from the phase separator 920 to generate a random signal 951 whose statistical characteristic is similar to an M-th cluster reception signal.

The SNR estimator estimates an SNR using an equalized signal output 822 of the multi-equalizer FIR filter 840, and provides the same to the noise generator 990. The noise generator 990 generates and outputs a noise signal based on the estimated SNR. At this point, the SNR estimator 980 and the noise generator 990 may improve a convergence performance of an LMS algorithm of the M cluster LMS units 970, 972, 974 by modeling a noise using Additive White Gaussian Noise (AWGN) and artificially generating a noise signal with respect to a noise and an interference portion that cannot be modeled by the signal reconstruct filter.

The adder 960 adds statistical random signals 931, 941, 951 output from the M signal reconstruct filters for cluster 930, 940, 950, and a noise signal of the noise generator 990 to output the same signal to the M cluster LMS units 970, 972, 974. At this point, an output signal 961 of the adder 960 becomes a random signal whose statistical characteristic is similar to a multi-delay cluster reception signal.

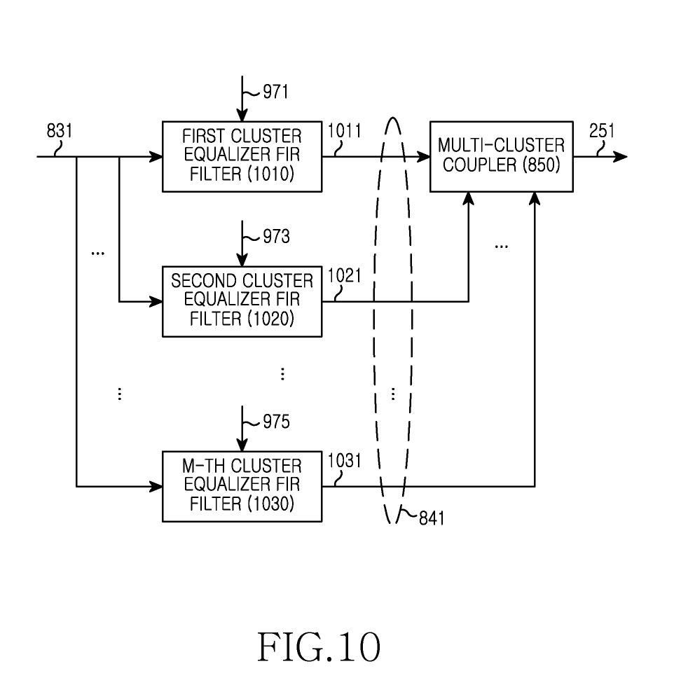

The first cluster LMS unit 970 generates and outputs a tap coefficient 971 of a first cluster equalizer FIR filter 1010 as illustrated in FIG. 10 by performing adaptive filtering on the signal 961 whose statistical characteristic is similar to the multi-cluster reception signal using the random signal 911 output from the random signal generator 910, that is, the random signal 911 whose statistical characteristic is similar to a transmission signal of a base station as a reference signal.

The second cluster LMS unit 972 generates and outputs a tap coefficient 973 of a second cluster equalizer FIR filter 1020 as illustrated in FIG. 10 by performing adaptive filtering on the signal 961 whose statistical characteristic is similar to the multi-cluster reception signal using the random signal 921 output from the phase separator 920, that is, the random signal 921 used for transmission signal modeling of the second signal reconstruct filter for cluster 940 as a reference signal.

Also, the M-th cluster LMS unit 974 generates and outputs a tap coefficient 975 of an M-th cluster equalizer FIR filter 1030 as illustrated in FIG. 10 by performing adaptive filtering on the signal 961 whose statistical characteristic is similar to the multi-cluster reception signal using the random signal 922 output from the phase separator 920, that is, the random signal 922 used for transmission signal modeling of the M-th signal reconstruct filter for cluster 950 as a reference signal.

Here, the equalizer FIR filter tap coefficient generated by the M cluster LMS units 970, 972, 974 is expressed by Equation (2).

$${W}_{i} = {[ {H}_{i} {H}_{i}^{H} + {\sum }_{j = 2 , j \neq i}^{M} {H}_{j} {H}_{J}^{H} + {σ}^{2} I ]}^{- 1} {H}_{i}^{H} \qquad ( 2 )$$

where Wᵢ is an equalizer FIR filter coefficient for an i-th delay cluster, Hⱼ is a channel estimated value for a j-th delay cluster, i and j have a value of 1, 2, . . . , M. Also, σ²I is a noise signal generated by the noise generator 790.

The multi-cluster equalizer FIR filter 840 performs an equalize process on respective multi-delay clusters using a signal 831 stored in and transferred from the chip buffer 830 and the FIR filter coefficients 921, 971, 973, 975 output from the multi-cluster adaptive equalizer 820. That is, as illustrated in FIG. 10, the multi-cluster equalizer FIR filter 840 includes M equalizer FIR filters 1010, 1020, 1030 to apply FIR filter tap coefficients 971, 973, 975 corresponding to respective delay clusters to the signal 831 output from the chip buffer 930 via the respective M equalizer FIR filters 1010, 1020, 1030 and perform a separate equalize process for each delay cluster.

The multi-cluster coupler 850 receives equalized signals 841, 1011, 1021, 1031 for each cluster output from the multi-cluster equalizer FIR filter 840, and corrects a time difference between delay clusters to add the input signals 841, 1011, 1021, 1031.

FIG. 11 is a detailed block diagram illustrating an equalize receiver for applying a diversity technique to a delay cluster according to an exemplary embodiment of the present invention.

Referring to FIG. 11, the equalize receiver includes a multi-cluster delaying unit 1110, a multi-cluster channel estimator 1120 which outputs estimated value 1121, a multi-cluster diversity adaptive equalizer 1130, a multi-cluster PN generator 1140 which outputs a generated PN code 1141, a multi-cluster chip buffer 1150 which outputs a signal 1151, a multi-cluster equalizer FIR filter 1160 which outputs an equalized signal output 1132, and a multi-cluster coupler 1170. Here, since the multi-cluster channel estimator 1120 and the multi-cluster PN generator 1140 are the same as the multi-cluster channel estimator 500 and the multi-cluster PN generator 510 illustrated in FIG. 5 and perform the same operations, descriptions thereof are omitted.

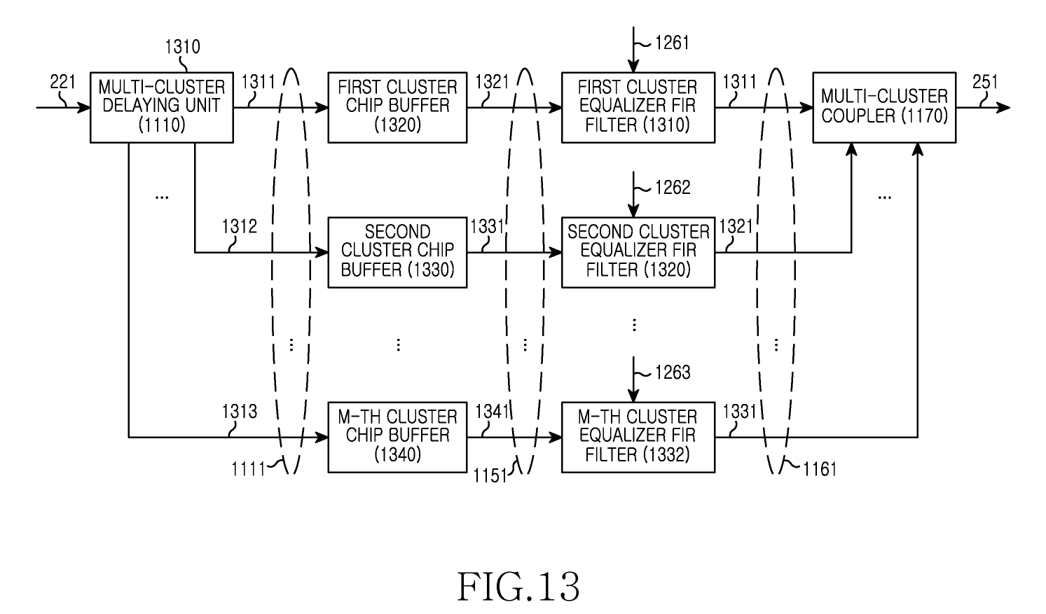

The multi-cluster delaying unit 1110 generates different output timings with respect to an input predetermined signal. That is, the multi-cluster delaying unit 1110 outputs data for the respective delay clusters at the same time by compensating for an output time by a delay offset with respect to the respective delay clusters. At this point, the multi-cluster delaying unit 1110 may be configured using buffers having different output addresses, respectively, while having a constant input address. Particularly, as illustrated in FIG. 13, the multi-cluster delaying unit 1110 outputs input data to M cluster chip buffers 1320, 1330, 1340 for each delay cluster. The multi-cluster delaying unit 1110 compensates for a delay offset with respect to respective delay clusters to control output timings of data (1311, 1312, 1313), 1111 provided to the respective cluster chip buffers 1320, 1330, 1340. For example, when outputting input data to the first cluster chip buffer 1320, the multi-cluster delaying unit 1110 outputs data after a first delay offset to the second cluster chip buffer 1330 with consideration of the first delay offset between the first delay cluster and the second delay cluster. Likewise, when outputting input data to the first cluster chip buffer 1320, the multi-cluster delaying unit 1110 outputs data after an (M−1)-th delay offset to the M-th cluster chip buffer 1340 with consideration of the (M−1)-th delay offset between the first delay cluster and the M-th delay cluster.

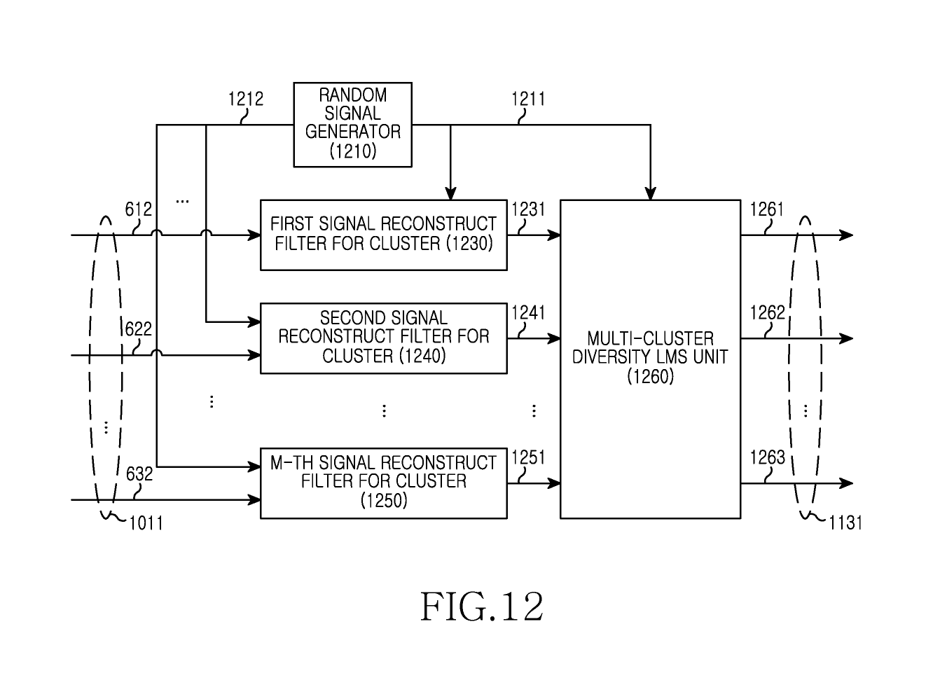

The multi-cluster diversity adaptive equalizer 1130 simultaneously generates equalizer FIR filter tap coefficients 1131 for the respective multi-delay clusters using channel estimated values (612, 622, 632), 1011 output from the multi-cluster channel estimator 1120, and outputs the simultaneously generated tap coefficients 1131 to the multi-equalizer FIR filter 1160. Particularly, the multi-cluster diversity adaptive equalizer 1130 is configured as illustrated in FIG. 12 to simultaneously generate equalizer FIR filter tap coefficients 1261, 1262, 1263 for the respective multi-delay clusters. The multi-cluster diversity adaptive equalizer 1130 is described below in detail with reference to FIG. 12.

Referring to FIG. 12, the multi-cluster diversity adaptive equalizer 1130 includes a random signal generator 1210, M signal reconstruct filters for cluster 1230, 1240, 1250, and a multi-cluster diversity LSM unit 1260.

First, the random signal generator 1210 generates and outputs a random signal 1212 whose statistical characteristic is similar to a transmission signal of a base station. For example, the random signal generator 1210 may be a memory where 1 or −1 of a length of 2048 are mixed at random and stored.

The first signal reconstruct filter for cluster 1230 receives a channel estimated value 612 of the main delay cluster output from the first cluster estimator 611 to set the same as a FIR filter tap coefficient, and filters a random signal 1211 output from the random signal generator 1210 to generate a random signal 1231 whose statistical characteristic is similar to a main cluster reception signal.

The second signal reconstruct filter for cluster 1240 receives a channel estimated value 622 of the second delay cluster output from the second cluster estimator 621 to set the same as a FIR filter coefficient, and filters a random signal 1212 output from the random signal generator 1210 to generate a random signal 1241 whose statistical characteristic is similar to the second cluster reception signal.

Likewise, the M-th signal reconstruct filter for cluster 1250 receives a channel estimated value 632 of the M-th delay cluster output from the M-th cluster estimator 631 to set the same as a FIR filter tap coefficient, and filters a random signal 1212 output from the random signal generator 1210 to generate a random signal 1251 whose statistical characteristic is similar to the M-th cluster reception signal.

The multi-cluster diversity LMS unit 1260 simultaneously receives random signals 1231, 1241, 1251 output from signal reconstruct filters 1230, 1240, 1250 corresponding to respective delay clusters, and performs Linear Minimum Mean Square Error (LMMSE) coupling on the random signals 1231, 1241, 1251 output from the signal reconstruct filters 1230, 1240, 1250 corresponding to the respective delay clusters using a statistical random signal output from the random signal generator 1210 as a reference signal to simultaneously generate equalizer FIR filter coefficients 1131, 1261, 1262, 1263 corresponding to the respective delay clusters. Here, the equalizer FIR filter coefficients corresponding to the respective delay clusters generated by the multi-cluster diversity LMS unit 1260 are expressed by Equation (3).

W=[HH^{H}+σ²I]⁻¹H^{H} (3)

At this point, W is expressed by Equation (4), and H is expressed by Equation (5).

$$W = ( \begin{matrix}{W}_{1} \\ {W}_{2} \\ ⋮ \\ {W}_{M}\end{matrix} ) \qquad ( 4 )$$

where, W_{M} is an equalizer FIR filter coefficient for an M-th delay cluster.

$$H = ( \begin{matrix}{H}_{1} & 0 & … & 0 \\ 0 & {H}_{2} & … & 0 \\ ⋮ & ⋮ & ⋱ & ⋮ \\ 0 & 0 & … & {H}_{M}\end{matrix} ) \qquad ( 5 )$$

where H_{M} is a channel estimated value of an M-th delay cluster.

As illustrated in FIG. 13, the multi-cluster equalizer FIR filter 1160 performs an equalize process on respective multi-delay clusters using signals (1321, 1331, 1341), 1151 stored in and transferred from the respective M multi-cluster chip buffers 1320, 1330, 1340 and FIR filter coefficients (1261, 1262, 1263), 1131 output from the multi-cluster diversity LMS unit 1260 by including M multi-cluster equalizer FIR filters 1310, 1320, 1332.

The multi-cluster coupler 1170 receives signals 1161, 1311, 1321, 1331 equalized for each delay cluster output from the multi-cluster equalizer FIR filter 1160, and adds the input signals 1161, 1311, 1321, 1331.

Accordingly, an exemplary embodiment of the present invention has an effect of reducing a performance loss under a reception environment such as a cell boundary or a downtown where delay spread of multi-path fading is large to obtain a high speed reception performance while preventing operation complexity of an adaptive equalizer from increasing by controlling an operating method of a receiver depending on delay cluster distribution of multi-path signals and receiving the multi-path signals in a wireless communication system of a multi-path fading environment.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus of an equalizer-based receiver in a wireless communication system, the apparatus comprising:
a reception multi-path detector for grouping reception signals according to a predetermined reference to classify the reception signals into a plurality of delay clusters, and for estimating a position of the plurality of delay clusters;
a controller for determining whether the plurality of delay clusters exist within a predetermined threshold range based on a result of the estimated position, and for controlling an operation mode of the equalizer-based receiver depending on a result of the determination; and
an equalize receiver for performing one of a mode for removing an interference between the plurality of delay clusters and a mode for applying a diversity technique to a delay cluster under control of the controller.

2. The apparatus of claim 1, wherein, when the plurality of delay clusters do not exist within the predetermined threshold range, the equalize receiver removes an interference between the plurality of delay clusters under control of the controller, and the equalize receiver comprises:
a multi-cluster PN generator for generating a PN code for the respective delay clusters;
a multi-cluster channel estimator for estimating a channel of the respective delay clusters; and
a multi-cluster adaptive equalizer for generating a filter coefficient with consideration of an interference of other delay clusters with respect to a specific delay cluster using the channel estimated result of the respective delay clusters.

3. The apparatus of claim 1, wherein the multi-cluster adaptive equalizer comprises:
a random signal generator for generating a first random signal whose statistical characteristic is similar to a transmission signal of a transmission terminal;
a phase separator for generating a plurality of random signals having a phase different from the random signal;
a plurality of signal reconstruct filters for cluster, for receiving a channel estimated value of respective delay clusters from the multi-cluster channel estimator to set the same as a FIR filter tap coefficient, and filtering the first random signal and the plurality of random signals having the different phase to generate a random signal whose statistical characteristic is similar to a reception signal of the respective delay clusters;
an adder for adding random signals of the respective delay clusters generated by the plurality of signal reconstruct filters for cluster; and
a first cluster LMS unit for performing adaptive filtering on the added signal using the first random signal to generate an equalizer FIR filter coefficient for a specific delay cluster.

4. The apparatus of claim 3, further comprising:
a plurality of cluster Least Mean Square (LMS) units for performing adaptive filtering on the added signal using one of the random signals having the different phase to generate the equalizer FIR filter coefficient for the plurality of delay clusters.

5. The apparatus of claim 4, further comprising:
a multi-cluster equalizer FIR filter for equalizing a signal of each delay cluster using an equalizer FIR filter tap coefficient for each delay cluster output from the first cluster LMS unit and the plurality of cluster LMS units; and
a coupler for coupling signals of respective equalized delay clusters output from the multi-equalizer FIR filter.

6. The apparatus of claim 1, wherein, when a plurality of delay clusters exist within a predetermined threshold range, the equalize receiver applies a diversity technique for the plurality of delay clusters under control of the controller, and the equalize receiver comprises:
a multi-cluster delaying unit for compensating for an output time by a delay offset with respect to the plurality of respective delay clusters to output data for the respective delay clusters at the same time;
a multi-cluster PN generator for generating a PN code for the respective delay clusters;
a multi-cluster channel estimator for estimating a channel of the respective delay clusters; and
a multi-cluster diversity adaptive equalizer for simultaneously generating an equalizer FIR filter tap coefficient for the respective multi-delay clusters using the channel estimated result of the respective delay clusters.

7. The apparatus of claim 6, wherein the multi-cluster diversity adaptive equalizer comprises:
a random signal generator for generating a first random signal whose statistical characteristic is similar to a transmission signal of a transmission terminal;
a multi-signal reconstruct filter for cluster, for receiving a channel estimated value of respective delay clusters from the multi-cluster channel estimator to set the same as a FIR filter tap coefficient, and for filtering the first random signal to generate a random signal whose statistical characteristic is similar to a reception signal of the respective delay clusters; and
a diversity LMS unit for performing Linear Minimum Mean Square Error (LMMSE) coupling on random signals of the respective delay clusters generated by the multi-signal reconstruct filter for cluster with reference to the first random signal to simultaneously generate equalizer FIR filter coefficients corresponding to the respective delay clusters.

8. The apparatus of claim 6, further comprising:
a multi-cluster chip buffer for receiving a signal of each delay clusters, temporarily storing the received signals, and for outputting the signals under timing control of the multi-cluster delaying unit;
a multi-cluster equalizer FIR filter for equalizing a signal of each delay cluster output from the multi-cluster chip buffer using the equalizer FIR filter tap coefficient for the respective multi-delay clusters; and
a coupler for coupling signals of the equalized respective delay clusters output from the multi-equalizer FIR filter.

9. The apparatus of claim 6, wherein the predetermined threshold range is set using a window size of the multi-cluster delaying unit.

10. A method for operating an equalizer-based receiver in a wireless communication system, the method comprising:
grouping reception signals according to a predetermined reference to classify the reception signals into a plurality of delay clusters;
estimating a position of the plurality of delay clusters;
determining whether the plurality of delay clusters exist within a predetermined threshold range using a result of the estimated position; and
operating in one of a mode for removing an interference between the plurality of delay clusters and a mode for applying a diversity technique to a delay cluster depending on a result of the determination.

11. The method of claim 10, further comprising:
when the plurality of delay clusters do not exist within the predetermined threshold range as a result of the determination, operating in a mode for removing an interference between the plurality of delay clusters,
wherein the operating in the mode for removing the interference between the plurality of delay clusters comprises:
generating a PN code for the respective delay clusters;
estimating a channel of the respective delay clusters; and
generating a filter coefficient with consideration of an interference of other delay clusters with respect to a specific delay cluster using the channel estimated result of the respective delay clusters.

12. The method of claim 10, wherein the generating of the filter coefficient using the channel estimated result of the respective delay clusters comprises:
generating a first random signal whose statistical characteristic is similar to a transmission signal of a transmission terminal;
generating a plurality of random signals having a phase different from the random signal;
receiving a channel estimated result of respective delay clusters to set the same as a FIR filter tap coefficient, and filtering the first random signal and the plurality of random signals having the different phase to generate a random signal whose statistical characteristic is similar to a reception signal of the respective delay clusters;
adding random signals of the respective delay clusters generated by the plurality of signal reconstruct filters for cluster; and
performing adaptive filtering on the added signal using the first random signal to generate an equalizer FIR filter coefficient for a specific delay cluster.

13. The method of claim 12, further comprising:
performing adaptive filtering on the added signal using one of the random signals having the different phase to generate the equalizer FIR filter coefficient for the plurality of delay clusters.

14. The method of claim 13, further comprising:
equalizing signals of respective delay clusters using the equalizer FIR filter coefficient for the specific delay cluster and the equalizer FIR filter coefficient for the plurality of delay clusters; and
coupling signals of the equalized respective delay clusters.

15. The method of claim 10, further comprising:
when the plurality of delay clusters exist within the predetermined threshold range as a result of the determination, operating in a mode for applying a diversity technique for the plurality of delay clusters,
wherein the operating in the mode for applying the diversity technique for the plurality of delay clusters comprises:
controlling timing for the respective delay clusters using a delay offset with respect to the plurality of delay clusters;
generating a PN code for the respective delay clusters;
estimating a channel of the respective delay clusters; and
simultaneously generating an equalizer FIR filter tap coefficient for the respective multi-delay clusters using the channel estimated result of the respective delay clusters.

16. The method of claim 15, wherein the simultaneously generating of the equalizer FIR filter tap coefficient for the respective multi-delay clusters comprises:
generating a first random signal whose statistical characteristic is similar to a transmission signal of a transmission terminal;
receiving a channel estimated value of respective delay clusters from a multi-cluster channel estimator to set the same as a FIR filter tap coefficient, and filtering the first random signal to generate a random signal whose statistical characteristic is similar to a reception signal of the respective delay clusters; and
performing Linear Minimum Mean Square Error (LMMSE) coupling on random signals of the respective delay clusters generated by a multi-signal reconstruct filter for cluster with reference to the first random signal to simultaneously generate equalizer FIR filter coefficients corresponding to the respective delay clusters.

17. The method of claim 15, further comprising:
temporarily storing signals of respective delay clusters and outputting the stored signals under timing control;
equalizing the signals of the respective delay clusters temporarily stored and output using the equalizer FIR filter tap coefficients for the respective multi-delay clusters; and
coupling the equalized signals of the respective delay clusters.
